(19) United States
(12) Patent Application Publication
(10) Pub. No.: US 2013/0018766 A1
(43) Pub. Date: Jan. 17, 2013

(54) MINIMALIST APPROACH TO ROADWAY ELECTRIFICATION

(71) Applicant: Edwin Roy Christman, East Palatka, FL (US)

(72) Inventor: Edwin Roy Christman, East Palatka, FL (US)

(21) Appl. No.: 13/424,442

(22) Filed: Mar. 20, 2012

Related U.S. Application Data
(60) Provisional application No. 61/506,767, filed on Jul. 12, 2011.

(51) Int. Cl. G06Q 30/04; B60L 5/12

(52) U.S. Cl. 705/34; 191/64

(57) ABSTRACT

Method of commerce and system components that enable the sale of electricity on-request to independent vehicle operators for propulsion. Electricity could be delivered by conventional roadway overhead electric line components (see FIG. 2). Vehicles would be equipped with a computer-like component that contains an electricity meter, flow switches, and wireless communications capabilities (see FIG. 14) to communicate with an operations (12) computer site. Site would have customer credit profiles for approving distribution, wirelessly requested from customer vehicles. Vehicles would be additionally equipped with a robotic collector module (51). If implemented on a highway, the driver would request service while driving in an electrified lane via a user interface and, if approved, the robotic collector module (51) handles engaging electrical contact and disengaging when needed. Customer would be electronically billed for the electricity used. There is a continuous roadside monitoring network for improved safety and vehicle authentication (see FIG. 11, 12).

### CROSS-REFERENCE TO RELATED APPLICATIONS

This application claims priority to and the benefit of provisional patent application Ser. No. 61/506,767, filed Jul. 12, 2011 by the present inventor.

### FEDERALLY SPONSORED RESEARCH OR DEVELOPMENT

Not Applicable

### SEQUENCE LISTING OR PROGRAM

Not Applicable

### BACKGROUND OF THE INVENTION

1. Field of the Invention

The present invention is in the field of overhead electric line use on roadways for independently owned vehicle connection, safe and practical use, and real-time billing based on actual vehicle energy consumption.

2. Prior Art

After almost 75 years of dominance as the motor of choice for all automobiles and trucks, the internal combustion engine, has now created two worldwide problems. It is thought to be a major contributor to global warming because of its substantial carbon emissions and secondly, world demand for oil permanently exceeds supply thus a continuous upward pricing is occurring. A third area of concern is national security in that most oil production and oil reserves are in a very volatile area of the Middle East. The United States, for instance, now imports over 50% of the oil that it consumes. The entire U.S. transportation network of planes, trains, automobiles, trucks, buses, and boats, uses petroleum as a fuel with very few exceptions.

Research investments are well under way and are plentiful in areas of alternative fuels to supplement or replace petroleum. There are also investments in new battery technologies that could store enough energy to equate to an “automobile gas tank”. Large investments have included; ethanol production from com crops, hydrogen “fuel cells, hybrid gas/electric vehicles, biofuels, natural gas vehicles, advanced battery development, and battery powered electric motor vehicles. There are many other less significant development classes such as “smart car” development. In 2011, the U.S. President and the U.S. Department of Energy set as a goal to have one million electric vehicles on U.S. roads by 2015. This projection is based on futuristic sales projections of mostly start-up companies or substantially government funded enterprises. No company yet has a successful ongoing business in such vehicles at any volume. Several have tried and failed. Even if successful, these short range smaller electric vehicles by 2015 will amount to less than one half of one percent of the total vehicle population with even less impact on total vehicle travel.

As it stands, these efforts do not appear to be nearly enough to mitigate the increasing world demand for oil and should result in even higher prices for petroleum products well into the present and next decade. This is particularly true for the world's long haul trucking industries as none of the previously mentioned investment priorities apply to this industry.

A rare method of transportation, categorized as electric tram or trolley systems, currently receives no attention or investment. In the early 20^{th} century, however, virtually every major city in America had a trolley or “street car” system using overhead electric wires and electric motors for traction. The one current exception to this rarity is use on high-speed train transportation but it remains unclear how electricity has advanced this state of technology. High-speed trains have not been widely accepted. One reason is the land acquisition and construction cost is very high. The track construction alone is estimated at $25,000,000 per mile, Another rarely implemented solution is the two-wire “trolley bus” which uses regular street tires thus there is no guide or rail. Cities such as San Francisco, Dayton, and Boston, have used these type systems for decades but they only represent of small portion of their overall transportation networks.

Overhead electric contact systems have been significantly limited in use due to nine factors; [1.] A vehicle must stay aligned and in contact with the overhead electric line to have power thus a guide or rail system is optimal as the line and rail can be precisely constructed to ensure this alignment. [2.] Systems have been limited to public transportation where the rider pays a fee for service. All overhead lines, vehicles, and power substations are then owned by one closed loop business entity. [3.] There are navigation limitations in that tensioned wires create a straight line thus curves and turns, and actions such as going in reverse are problematic. [4.] Vehicles with electric motors that also have significant battery reserves (or auxiliary engine power), which could enter and exit the overhead electric contact system, have not existed or have been cost prohibitive. [5.] The means of a track independent vehicle making contact and releasing contact with the overhead wires has been a manual to semi-automatic process involving an operator specially trained in the technology. [6] Even though high-speed electric trains achieve speeds in excess of 150 mph, conventional wisdom is that a two-wire trolley bus system cannot go faster than 40 mph. [7.] Trolley systems, whether bus or rail, are thought to be more expensive overall than a conventional diesel bus. [8.] Trolley overhead wires are thought to be unsightly and therefore undesirable in some cities and neighborhoods. The lines are also thought to be dangerous to pedestrians. [9.] Rails in the community roadway are considered undesirable and annoying to other drivers of legacy gasoline vehicles.

There has also never been an environment using overhead electric contact line where a vehicle with an electric motor, foreign to the owner of the overhead system, could automatically attach and use electricity “on-demand” to propel the vehicle, and then pay the owner just for the electricity consumed until detaching.

In the unrelated and dissimilar industries of rapidly advancing smart mobile phone communications and computer gaming, costs associated with global position sensing, accelerometer , multi-axis gyroscope, and image sensing technology have been driven way-down while function and reliability is greatly improved. Component quantities now go into the tens of millions.

Computer and communication technology has now advanced to the state that an average driver can routinely talk on the phone, type and receive text messages or email, or even participate in a video conference call, all while driving a legacy vehicle on a public roadway. A driver can now also pay their bills online, do some online shopping, or even read an electronic version of the New York Times newspaper. This now raises the question of roadway safety and has generated a new term referred to as “distracted driving”. More importantly, it raises the question of whether the very concept of “driving” a personal vehicle is approaching functional obsolescence in this current human productivity driven world economy. For the majority of trips people take in their daily lives, computer and communications technology now provides many other functional opportunities for that time. Mobile communication tower placements typically follow along major highways because so many people are using mobile devices and driving at the same time.

Coincidently, electrical power transmission along major roadways has existed for a century. None of this electrical energy is applied to vehicle transportation even though it is very accessible at most every roadway. Huge distribution infrastructure costs by utility companies run across and along almost all roadways. Today none of these utility power plants use oil as a fuel because of its higher cost per of unit of electricity delivered. It remains highly likely that more environmentally friendly or renewable fuels will arrive at these utilities over the next 10 to 25 years.

Prices per gallon for diesel fuel or gasoline are at all-time highs. In addition to new fuel and battery technology, bright minds have focused mainly on other vehicle centric ideas regarding improved future personal vehicle transportation. The common denominator in most of these solutions is a much smaller and lighter vehicle. Others have focused on the “smart car” that can “platoon” with other vehicles forming a dense chain of vehicles which can achieve aerodynamic benefit similar to race car “drafting”. Others have suggested a “dual mode” vehicle that can run on a roadway but also jump on a guide-track or rail. Still others have designed vehicles that fold up or compress for optimized urban parking. Still others have suggested that high-speed trains are the solution and will eventually reduce or eliminate the need for personal vehicle transportation. Still others have proposed the roadway pavement itself should be implanted with electrical current that can then be transmitted via the underbelly of a vehicle through the “wireless” process generally referred to as electrical induction to an electric motor drive system. Still others have designed small urban “networked” vehicles with cameras and sensors that can almost drive themselves and completely avoid accidents.

Large Class 8 trucks hereafter referred to as tractor-trailers remain mostly unchanged going into future years. There is forecasted to be a modest improvement due to improved tractor-trailer aerodynamics and overall drivetrain efficiencies. There have been several hybrid electric drive assemblies and vehicles built without commercial success. This is primarily due to the fact that recapturing energy via regenerative braking has little upside value since these vehicles mostly operate on highways and rarely brake. A battery capable of propelling an 80,000 pound vehicle at a high rate of speed over a long distance would likewise be prohibitive in size, weight, and cost.

As of 2011, little has actually changed on the streets of America in decades. Advances in engine efficiencies have been offset by increases in vehicle size. The U.S. uses slightly less petroleum compared to previous years but this is due primarily to higher prices and the current economic recession. This recession was partially brought about by the large consumption of increasingly higher priced petroleum products. U.S. consumers spend approximately 300+ billion dollars a year on gasoline for personal vehicle transportation or 3% of the GDP. It is stated that the U.S. represents 4% of the world population but consumes 21% of the world's oil production—roughly 20 million barrels per day. Heavy commercial trucks represent approximately 14% of total consumption. Class 8 combination trucks (tractor-trailers) alone represent 9% or approximately 29 billion gallons of diesel fuel per year.

### SUMMARY OF THE INVENTION

The present invention entails a method of providing continuous electricity, on-demand, to moving vehicles traveling on conventional roadways in sufficient quantity to propel a commercial long haul combination truck or other large vehicle over long distances, then bill for electricity use and manage users accordingly. An object of this invention is to create a seismic, rather than a negligible, reduction in petroleum use for transportation purposes within the U.S. by making alternative energy sources available and at lower costs to the user. The totality of the further described components comprises a business method for enabling and operating such an environment.

The preferred embodiment of this invention is intentionally minimalist yet maximizes features central to initial enabling of this new transportation business environment (see FIG. 1). It entails constructing and energizing mostly conventional overhead contact system components (hereafter also referred to as OCS) along the outside or leftmost lanes only of U.S. interstate highways (see FIG. 2). The contact wires would be directly over the center of the lane or a certain location relative to the center, without regard for how level the lane itself is. The contact wire shall maintain a height of 6 meters or a height determined by collaboration with stakeholders. The initial market opportunity for electric motor propulsion is thus made possible for Class 8 combination trucks (tractor-trailers). Early users are envisioned to be diesel tractors with trailers upgraded to contain electric motor kits. FIGS. 3, 4, and 5 illustrate such vehicles with a new robotic collector mechanism of this invention. An established feature of the embodiment is that it leverages on the fact that interstate roads, by definition, are mostly straight, without intersections, non-stop, no reverse direction, and for higher speed travel, Overpasses over these roads are mainly limited to a minimum height of 5 meters. It is possible to lower the contact line temporarily through such overpasses. Vehicles, as further described, could use battery or conventional diesel power, if necessary, in order to maintain traction when there is an overpass or other obstruction that does not conform to height and there is temporarily no overhead contact line.

A cross lane view is illustrated in FIG. 2 of an OCS implementation on a divided three lane roadway. The preferred embodiment includes full guard rails 9 protecting the OCS mast poles 4 thus reducing the potential for electrical damage as a result of vehicle accidents. A breakdown lane 2 can also be maintained between the electrified lane 1 and the guard rail 9. Other cars and trucks as well legacy tractor-trailers 8 can continue traveling as normal. The conventional mast pole 4 is enhanced with computer 6 and wireless communications 5 and other camera 3 sensor technologies to improve operations and roadway safety. Tractor-trailers with advanced robotic energy collectors of this invention 51 (see FIGS. 3, 4, and 5) would travel in the electrified lane 1. An alternative could be to electrify the inside lane when the outside lane is restricted or not a desirable location. A multiple electrified lane design is easily possible but the preferred embodiment heavily ways the need for an optimal transition period and a successful evolution from legacy petroleum powered vehicles. The truck only genesis also lends a higher degree of orderliness and financial return certainty which will be attractive to investors.

The present invention can also have a very positive impact on the environment in addition to creating a business method for providing cost effective electric power for transportation and reducing U.S. imports of oil. It enables the use of renewable energy such as wind, solar, or any other renewable sources to be used for vehicle propulsion. This positive impact is also due to the inherent improved operating efficiencies of modern power plants. State of the art, combined cycle, natural gas power plants can now achieve up to 62% operating efficiency. This compares to a new tractor-trailer powered by a natural gas engine with only 22% efficiency. The natural gas truck will use almost three times as much fuel and produce three times as much pollution to travel the same distance. The safety and distribution issues associated with natural gas and petroleum filling stations for such trucks could also be reduced as natural gas distribution would be limited to power plants where professionals manage these issues and petroleum would not be used at all.

Another important object of this invention is to cause investment in renewable energy sources to now be directly focused at these much more expensive petroleum based transportation issues rather than existing and less expensive to operate power plants. In so doing, renewables have a true positive rather than negative return on investment. American citizen's costs overall go down rather than up and the U.S. becomes a more competitive nation commercially while also improving the environment. A goal of this invention is to facilitate a national sense of urgency to maximize the opportunities for earlier rather than later construction of more environmentally friendly energy sources such as solar or wind. Since there is currently little demand for new power plants within the U.S. this new use and fresh revenue source creates the financial opportunity for significant new renewable energy investment dollars targeted at replacing legacy gasoline and oil infrastructure. Such an environment creates substantial investment grade employment opportunities for engineers and scientists, as well as many other professions who would be based in the U.S.

The environment also benefits if this invention is implemented worldwide. Countries like China and India may achieve broader implementation and achieve greater benefit because construction costs are significantly lower in these countries while the high worldwide price for oil remains the same. These countries are both net importers of oil thus it is in their national economic interest to move in the direction of this invention.

The further described minimalist approach to roadway electrification for commercial long haul vehicles eventually becomes the concrete foundation upon which a skyscraper of new transportation innovation can be built. The repurposing of the U.S. Interstate System for electric propulsion beyond its current use as a platform exclusively for legacy vehicles with internal combustion engines renews these pathways. These pathways become multi-dimensional which accelerates and leverages virtually ail of vehicle centric ideas previously envisioned by others.

### BRIEF DESCRIPTION OF THE DRAWINGS

FIG. 1 is a figurative view of the electrical highway infrastructure.

FIG. 2 is a cross-roadway view of vehicles and the overhead wire system.

FIG. 3 is a front view of an electrified tractor-trailer.

FIG. 4 is a rear view of an electrified tractor-trailer.

FIG. 5 is a side view of an electrified trailer with diesel powered tractor.

FIG. 6 is a cross view of a tractor with electric motor and battery only.

FIG. 7 is a front view of an automatic energy collector device (1).

FIG. 8 is a top view of an automatic energy collector device (1).

FIG. 9 is a front view of an alternative automatic energy collector device (2).

FIG. 10 is a top view of an alternative automatic energy collector device (2).

FIG. 11 is a panoramic roadway view with mast pole to pole segmentation.

FIG. 12 is a side view of a mast pole with sensors, computer, and camera.

FIG. 13 is a block diagram of the of mast pole segment manager module 6 with sensors.

FIG. 14 is a block diagram of the robotic collector module 51.

FIG. 15 is a flowchart tracing the fundamental process of the robotic collector module 51.

FIG. 16 is a flowchart of fundamental motion process of the robotic collector module 51.

FIG. 17 is a flowchart of the fundamental functions of the segment manager module 6.

### DETAILED DESCRIPTION OF THE INVENTION

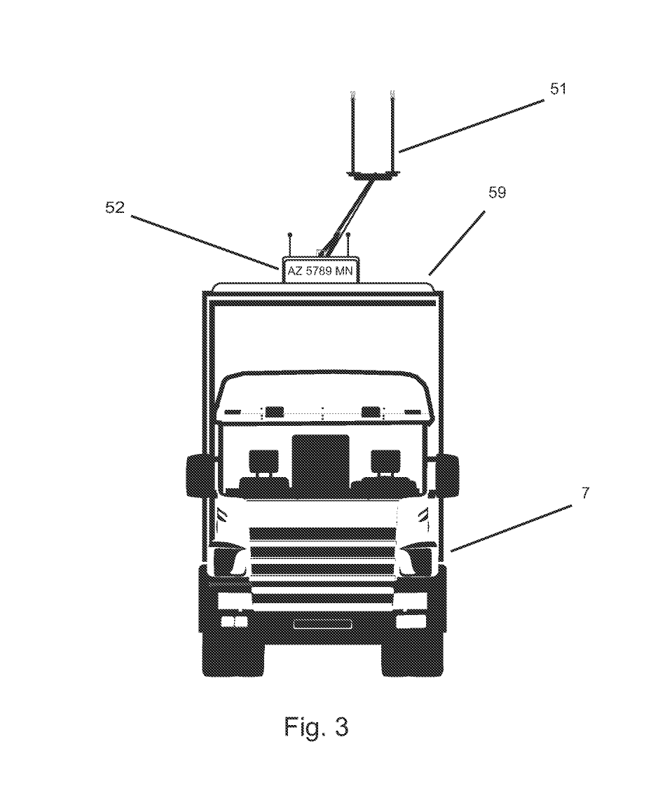

OCS electrical components are already well established and available for electric trolley bus and rail systems throughout the world. An object of this invention is to not reinvent OCS componentry rather to embrace it and its proven performance whenever possible in the first generation of this invention. Energy would then be sold for propulsion to licensed drivers of large hybrid diesel-electric combination trucks initially (see FIGS. 3, 4, and 5). These hybrid vehicles would incorporate an improved multi-axis energy collector with robotic control and vision sensing—a component of the present invention. This robotic collector module 51 would also have digital communications capabilities similar to a mobile cell phone or wireless internet appliance for identification, billing, and energy management. The envisioned seller of electrical energy and the robotic collector module 51 would likely, but not necessarily, be the local electric utility company 11 that currently exists as the highway traverses within its region. A digital electricity meter 76 would also be onboard such that the robotic collector module 51 can communicate actual usage to the utility company for billing purposes in real time. To simplify and enhance the user experience an independent organization may be established to handle the customer service and billing 13. Drivers should not be concerned that they just changed from one utility company to another, while driving. The billing itself would also become unmanageable if credit had to be requested and bills paid directly to each utility.

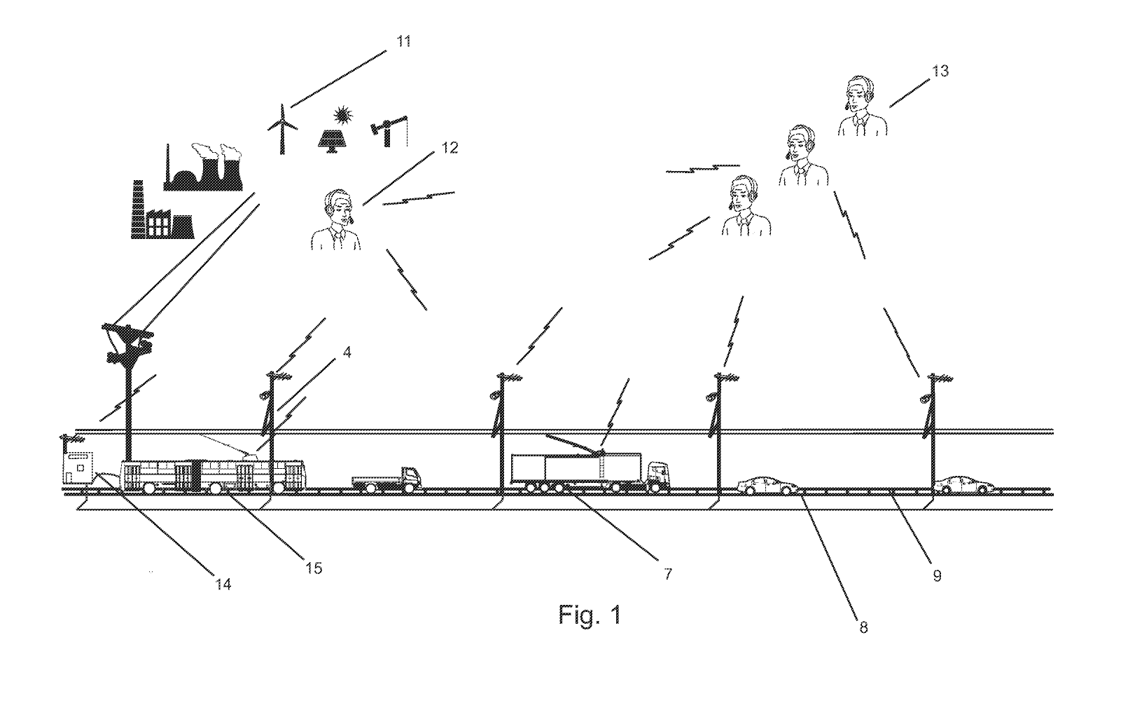

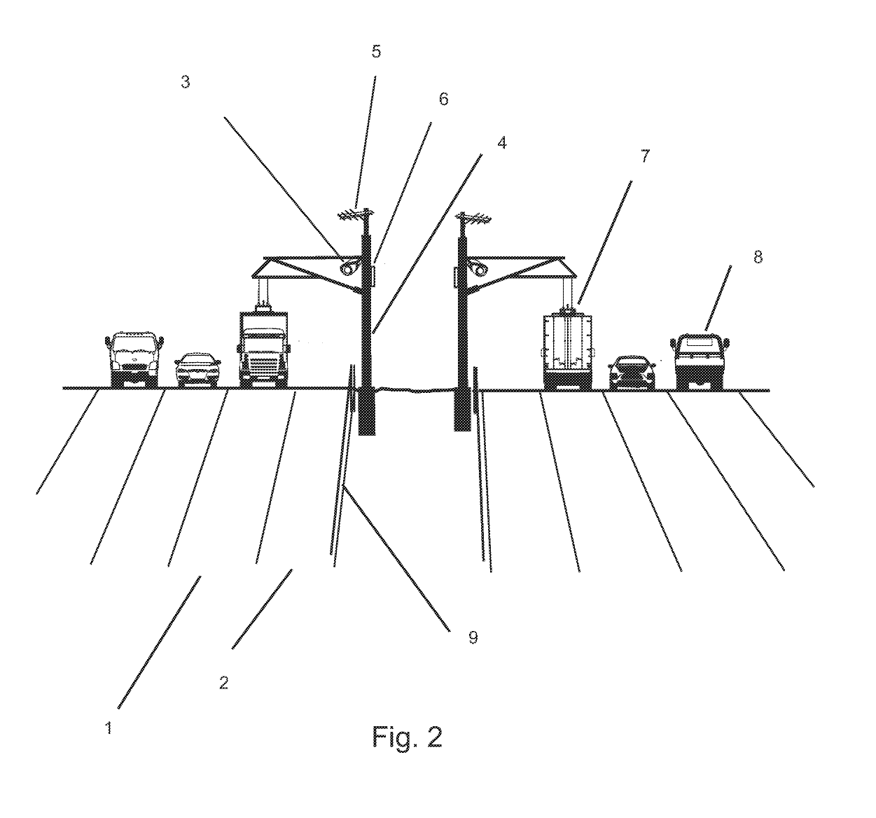

FIG. 1 illustrates the fundamental elements of the overall business. As the roadway traverses across regions of the country it is likely the actual fuel or energy source will change as the local utility company 11 providing electricity changes. Energy could come from coal, nuclear, wind, solar, or any of the many options available to these producers of electricity. The business essentially starts with the line operator or the entity in charge of receiving such electricity, transforming it at substations 14 and distributing energy on the OCS lines. The line operators' personnel have the direct operations role for interacting with the operations control system computer 12 and computer network highlighted by real-time video on each mast pole assembly 4. The operations control system computer 12 also manages overall system loading and use at any time. A primary object of this invention is focused on electrification of Class 8 tractors and/or trailers but additions to the electrified lane could very quickly be other vehicle types like buses 16. All other petroleum only vehicles 8 continue to use the roadway as normal. There are few retail stores or brick and mortar type interactions between users and the line operator. It is envisioned that authorized conventional truck stop locations will distribute and maintain the components of this invention. An online or customer support phone response environment 13 is preferred due to the mobile nature of the business.

An example environment would be to electrify the eastbound and westbound lanes of interstate I-10 from Santa Monica, Calif. to Jacksonville, Fla. This is a distance of 4000 kilometers crossing all eight of the southern most States and even more individual electric utility companies. Some of the details of the preferred embodiment may change to an alternative embodiment of this same invention since both State and Federal government involvement is inescapable. Again, it is envisioned that these products and services may be priced and sold through an aggregator who is mutually acceptable by the ail the stakeholders. Ownership of lines and equipment could be public, private, or a public-private partnership.

In the initial implementation, data and specifications such as current voltage and other initial smart appliance type communication settings would be made public by the line operator. Manufacturers of Class 8 tractors and trailers would make new equipment which may be a trailer equipped with power assist electric motors for use in combination with a legacy diesel tractor or a battery electric tractor for potential one hundred percent electric propulsion. It is also envisioned that complete hybrid kits will be developed such that the existing stock of trailers and tractors could be upgraded and used in conjunction with electric propulsion. Trailers that can power or propel themselves also opens more opportunities for combination trucks with multiple trailers as the tractor no longer needs the horsepower to “pull” all the trailers.

An intelligent, computerized, network connected, mast pole segment manager module 6 is another component of the present invention to achieve the important objectives of roadway safety, user and financial security, optimized traffic flow, and system management. In a futuristic embodiment of the present invention a driverless robotic truck could potentially drive this 2460 mile highway from Santa Monica, Calif. to Jacksonville, Fla. without ever stopping while in constant communication with the mast pole network. The OCS line under high reliability conditions is a “guide” that can be precisely followed and can act as an alternative to a conventional physical guide rail, as well as a being source of energy. Position sensing of the mast poles also provides bearing and location to the vehicle. Each mast pole contains a unique identification number based on its location thus providing real time access to vehicle location in addition to the onboard GPS vehicle sensing abilities. The most important strength of the preferred embodiment is its minimal intrusion onto the existing and highly critical interstate highway system of which over 95 percent of the vehicles will not initially be serviced by the present invention. The present invention “does no harm” to this majority of users. While the OCS wires will initially be over one lane only, this lane is not envisioned to be a dedicated lane like rapid transit. There are no rails or other electrical items embedded within the roadway as part of this invention. Commuters and other drivers can continue to use this lane as they always have. The single lane overhead line also creates minimal visual presentation or distraction to drivers of vehicles not involved in the electrification program.

An important feature of the segment manager module 6 of the present invention is its ability to sense pole collision impact or other system stresses and act to switch off overhead energy before such damage could cause an electrical line to fall dangerously onto the roadway. The state of the art within existing OCS line safety has been to provide highly sophisticated microprocessor based electronic monitoring of the current itself along conventional line segments or sections. Any observed variance of concern can cause an immediate automatic high-speed circuit break. Unfortunately, in many cases, localized damage may have already occurred. The segment manager module 6 increases the time range of protection by acting even before a current variance may appear. This functionality acts in similar fashion to a conventional vehicle airbag inflating before actual passenger impact. It is also envisioned that police or other emergency personnel can rapidly communicate with this roadway communication network in order to further de-energize desired segments or sections of OCS. The poles can also receive alarms from tractor-trailer controllers indicating significant trailer rocking due to high cross winds and, in combination with the operations control system computer 12, act to gracefully de-energize entire sections of roadway temporarily for overall roadway safety. Weather station technology including wind speed and direction as well as rain, sleet, or snow condition is envisioned on some mast poles (not shown but categorized under other sensors 106) interspersed along the highway according to need. Another important feature of the segment manager module 6 is image capture and verification of user vehicles 7 to prevent unauthorized use, as well as, vehicle 7 tracking for police authorities.

An example driving scenario would be as follows for a legacy diesel tractor upgraded with a hybrid trailer containing battery and electric drive systems. The driver would enter the highway as normal under the tractor supplied diesel engine power. The driver would then proceed to navigate to the outside, electrified, lane within the constraints of existing traffic. Once in this lane and while traveling at roadway speeds the driver would request electrical energy via in-cab user interface device such as a small touchscreen device with audio (not shown) similar to today's GPS devices, or a mobile smart phone. The robotic collector module 51 would acknowledge the request and then do a credit request via its multiple wireless communications to the line operator's customer and billing computer system 13. If approved, it would then communicate with the operations control system 12 of the line operator to confirm that the overhead line at the location the vehicle is traveling is operational and energized. The robotic collector module 51 would then activate the process of image sensing where and how high the power lines are relative to its at-rest location. Once determined the robotic collector module 51 would then direct the collector platforms, arms, and poles via robotic maneuvering towards the OCS lines until close enough to execute a connection. This process would occur through a series of image track and move loops happening in fractions of a second. This processor would occur concurrently for both collector poles. After the robotic collector module 51 is engaged with the overhead lines it would then sense for correct power conditions and if correct notify the driver via the cab user interface 107 and the vehicles power train manager 108 that energy is available and switch 109 on the power line. The image track and move cycle continues while the robotic collector module 51 is engaged thus as the vehicles position changes relative to the OCS lines an adjustment is constantly made to ensure optimal contact pressure and alignment.

The vehicle 7 would now have electrical energy from the overhead line and could now switch 111 to some level of electrical motor propulsion in combination with the diesel engine. The robotic collector module 51, via other direction and position sensors, can determine the position of the vehicle relative to the line at all times. If the driver leaves the electrified lane for any reason this module will sense this and automatically disengage the collector poles from the line. The driver can just navigate out of the lane to terminate service. Accelerometer sensors 105 will also provide data of collision impact of the vehicle 7 if an accident occurs and the robotic collector module 51 will disengage the collector and immediately notify via communications options the operations control computer system 12.

It is envisioned that the robotic collector module 51 components would be controlled or managed by the line operator similar to the method a mobile phone company distributes phones. Only components approved by the line operator would be made available in order ensure system integrity and manage system evolution. Also, similar to residential power utility companies, there has to be a finite line of responsibility. In residential electric power that point is the home electric meter. On one side is the power company's responsibility and on the other is the homeowner's responsibility. The dividing line here is the line at the meter 109 between the robotic collector module 51 controlled by the line operator and the vehicle power train manager 108 supplied by the vehicle manufacturer. It is also envisioned that the robotic collector module 51 will pass through to the power train manager 108 “smart appliance” type data similar to developments now being implemented for home appliances by electric utility companies. The line operator's operations computer system must constantly sense and manage current usage on each individual section of overhead line as to loading. If the load is light the system would approve maximum energy usage. If the load is heavier, the system may pass data indicating only a fraction of available energy should be activated by the power train manager 108. The operations control system computer 12 can direct a level change at any time based on local usage conditions. Because the meter 110 is part of the robotic collector module 51 system componentry, the line operator can verify if the directions are being followed by the vehicle.

A feature of the preferred embodiment is that communications between the active roadway vehicles and the line operator's computer systems can fail and the overhead line can remain active under curtains conditions. Once communication is reestablished, each vehicle can report updated usage from the on-board meter. One billing scenario would be that the vehicle, upon service request approval, receives a use “ticket” for a certain value of electric usage. If the vehicle is unable to communicate with the line operators computer system the vehicle can continue to use energy as long as the ticket value has not been fully utilized. At some point the driver and power train manager 108 would be notified energy is going to be switched off and the diesel engine is then the only manner of propulsion. If communication is restored the robotic collector module 51 will request a new ticket as it normally would do upon the ticket being fully utilized. Another form of billing would be the customary company open account. In this case the driver would not be concerned with billing. It would be the responsibility of someone at the office of his employer. A detailed billing and usage statement would be available online in similar fashion to a normal phone or utility bill.

Once the described preferred embodiment of an electrified interstate highway is in full implementation and the substantial infrastructure costs are being recovered there is unlimited room for further vehicle class additions particularly electric commuter buses.

Another large vehicle envisioned is an electric commuter car carrier that can haul 15 to 30 battery electric vehicles with drivers to business community drop off points where they can then drive to a now local office location thus avoiding car mileage distances potentially beyond the current capability of their battery power. These riders can potentially recharge their vehicle while they ride as well. Now converted to a rider as opposed to driver, people can also now freely and safely talk, text, or video chat on a smart phone or use other wireless internet devices without the stresses and dangers of commuter driving. It is envisioned that riders would review pick up locations and time availability via a smart phone app or internet application and then make a firm reservation. There would never be a situation of people physically competing for space or being in some sort of line. The vehicle density provided by such car carriers should actually free up roadway space such that the grid lock presently existing in many large urban areas is reduced thereby benefiting all vehicles. City to city car carrier routes would also greatly increase the practicality of otherwise short range battery electric vehicles. Such carriers might eventually combine or connect trailers together forming a train-like combination. Also, as these commuter vehicles get smaller in size and height it becomes possible to double deck the vehicles on the trailers. This is all enabled because the trailers themselves have their own propulsion power that can also be combined.

Another primary object of the invention is to provide lower cost of transportation versus the existing gasoline or diesel internal combustion engine for the future. An existing diesel tractor getting 6 mpg traveling at 65 mph would use 410 gallons of fuel which at $4.00 per gallon would cost $1,640 for the 2,460 mile trip from Santa Monica, Calif. to Jacksonville, Fla. An electric truck using an estimated equivalent continuous 150 kilowatts (200 horsepower) would use only $681 in electricity at $0.12 per kilowatt-hour. This is almost a 60% reduction. Electrified tractor-trailers would initially reduce U.S. petroleum consumption by 600,000 barrels per day according to the following scenario and expanded roadway. If the envisioned business were to charge a $3 per gallon equivalent and ⅓ of all class 8 combination trucks (29 billion gallons) converted to electricity the resulting business would have a gross profit stream of 13 billion dollars per year to apply to overhead line construction costs, other infrastructure and operating costs, interest, and profit. The roadway network could eventually be further expanded to include ⅔ of all class 8 combination trucks. The amount of oil saved would then approximate the entire amount of oil the U.S. imports from Saudi Arabia or Venezuela.

The projected overhead line construction cost is estimated at 2 million dollars per mile for the roadway electrification of this invention. To fully electrify the southern U.S. States (21,000 of 72,500+ interstate kilometers), a more practical preferred embodiment, from east to west would cost 26 billion dollars for construction with a projected additional 2 billion dollars per year in maintenance and depreciation. Costs for electric utility companies to connect and feed these lines are not included and will vary by area. It is estimated that these routes would achieve the previously mentioned conversion of ⅓ of all Class 8 combination truck usage. In addition to including three of the top four largest States by population; California, Texas, and Florida, the electrified routes would include the major metro areas of San Francisco, Calif., San Jose, Calif., Los Angeles, Calif., San Diego, Calif., Los Vegas, Nev., Phoenix, Ariz., Tucson Ariz., Albuquerque, N. Mex., Oklahoma City Okla., Dallas, Tex., Houston, Tex., Austin, Tex., San Antonio, Tex., New Orleans, La., Little Rock, Ariz., Jackson, Miss., Memphis, Tenn., Birmingham, Ala., Atlanta, Ga., Columbia, S.C., Charleston, S.C., Charlotte, N.C., Tampa, Fla., Orlando, Fla., Jacksonville, Fla., and Miami, Fla.

This preferred embodiment is selected based on truck traffic usage but also because snow and ice conditions are rare to non-existent. Such road conditions, while always a problem, would not be conducive to the initial phases of this invention. There will also be times within the above defined roadway that high winds or other weather factors would be severe enough that large sections of electrification would be temporarily de-energized for safety. Under such conditions, vehicles would propel themselves via full diesel power until re-entering an energized region. Information regarding such issues would be available via the in-cab user interface and the system communications network.

### Robotic Collector Module 51—Mechanics

Energy collectors on high-speed trains and rail in general are referred to as pantographs. They serve to establish contact with only one overhead line as the steel wheels and steel tracks can act as a return electrical line because steel is a sufficient conductor of electricity. Pantographs can be automatically raised for contact and then lowered because the rails and overhead lines are precisely constructed so that the overhead line is an exact height above the rails and exactly centered between the two rails. Since these geometric values are known, a pantograph can be permanently fixed within the center of a train and when it is raised a known height will always make contact with the overhead power line. To achieve a very high certainty of contact, these rail systems apply extraordinary care and precision to the quality and placement of the lines by deploying catenary supported designs. The pantograph itself can operate within some tolerance and does have a pan type head which provides for some lateral flexibility or movement. The pantograph is a rigid device in the sense that it only goes up or down essentially on one axis but that is all that is necessary for a rail system. Because of these tight tolerances high-speed electric rail systems have achieved reliable, everyday speeds of 150 mph and higher.

Trolley buses presented a solution in that the rail was not required. They can travel on the same roads as automobiles but because rubber tires are not sufficient conductors of electricity, two overhead lines are required. The second is the return line previously performed by the steel rail. Because trolley buses do not follow a rail there can be substantial lateral movement of the bus relative to the overhead line. As a result, a conventional solution has been to use two long poles with contact shoes each positioned on moving turret bases. The poles are now two axis devices and are able to go up and down as well as rotate from side to side. A third axis could be considered to be at the point where the shoe interfaces with the pole as there may be some rotational flexibility. The poles in most cases are of sufficient length (up to 7 meters) that a bus can actually pass another vehicle but stay in contact with the overhead line. The poles have a mechanism that applies an upward force at all times such that the distance between the overhead line and the bus can vary within a tolerance and contact is maintained so precision geometry is less critical. The two trolley pole system works effectively throughout the world but at lower speeds of less than 40 mph.

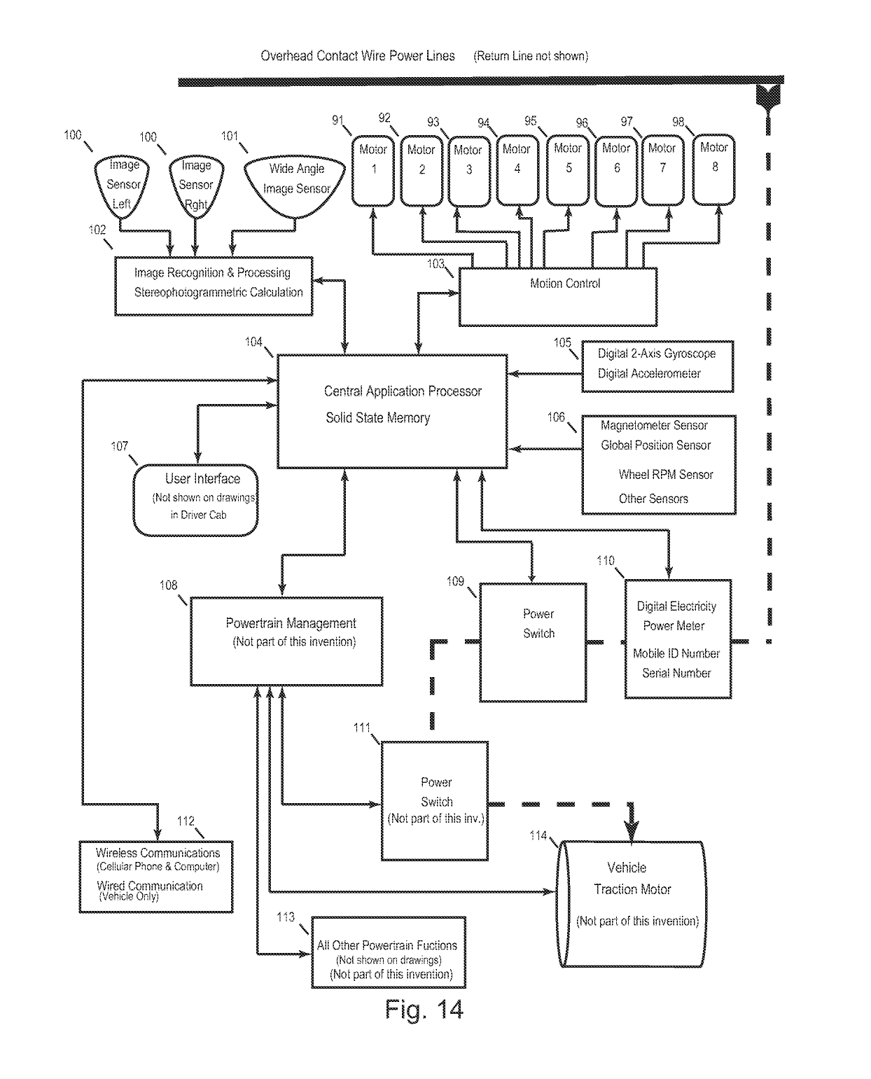

The robotic collector module 51 of this invention seeks to provide the benefits of both the precise fixed alignment of a rail pantograph and the agility of non-rail vehicle movement relative to the overhead line. It is designed with reliable two wire contact at speeds in the range of 65 mph in mind on catenary supported OCS lines. The design maintains two independently operating poles 24 thus providing greater line variance tolerance and less cost in the construction and maintenance of the lines. This is achieved by providing a robotic, multi-axis, articulating, aerodynamic, mechanism that is under computer control (see FIG. 14) and continuously repositions itself based on vision 28 29, gyroscope 105, accelerometer 105 and other image sensing of the placement of the line relative to the vehicle 7 in real time. One could simplistically think of this improved collector as a very athletic and agile man sitting on the roof of the truck who, on request, will jump up, look around and find the lines, and then precisely hold the contact shoes against the lines as the truck travels at any speed while swaying in the lane and as the height to the line varies and the road surfaces tilts.

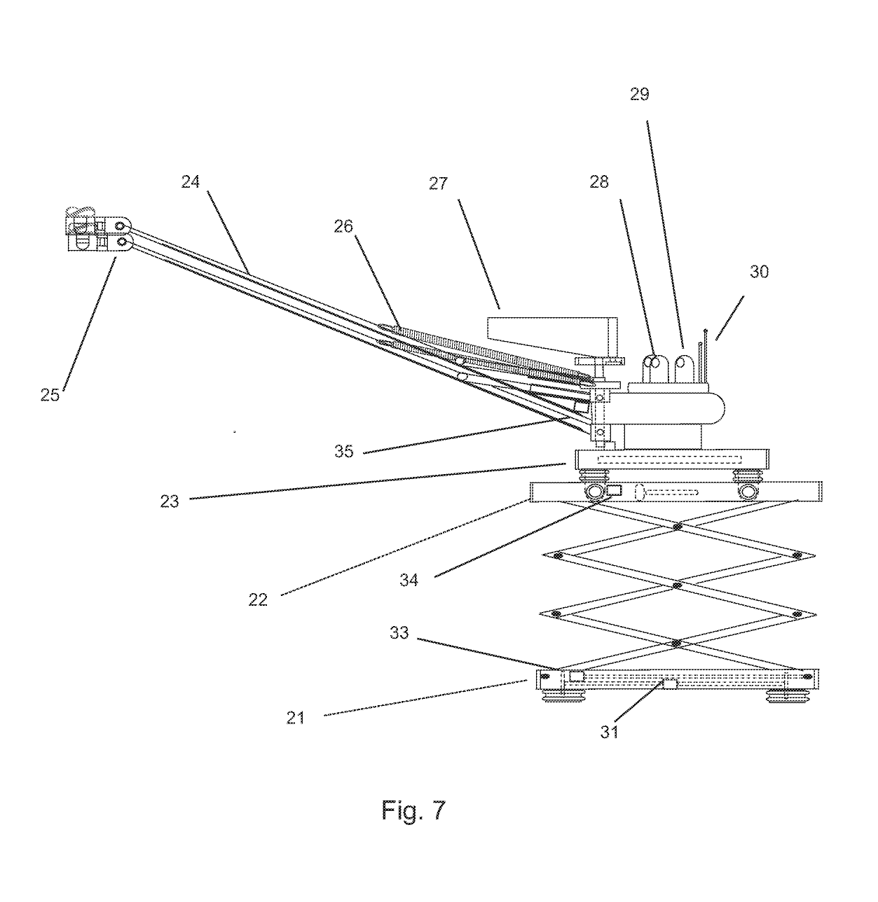

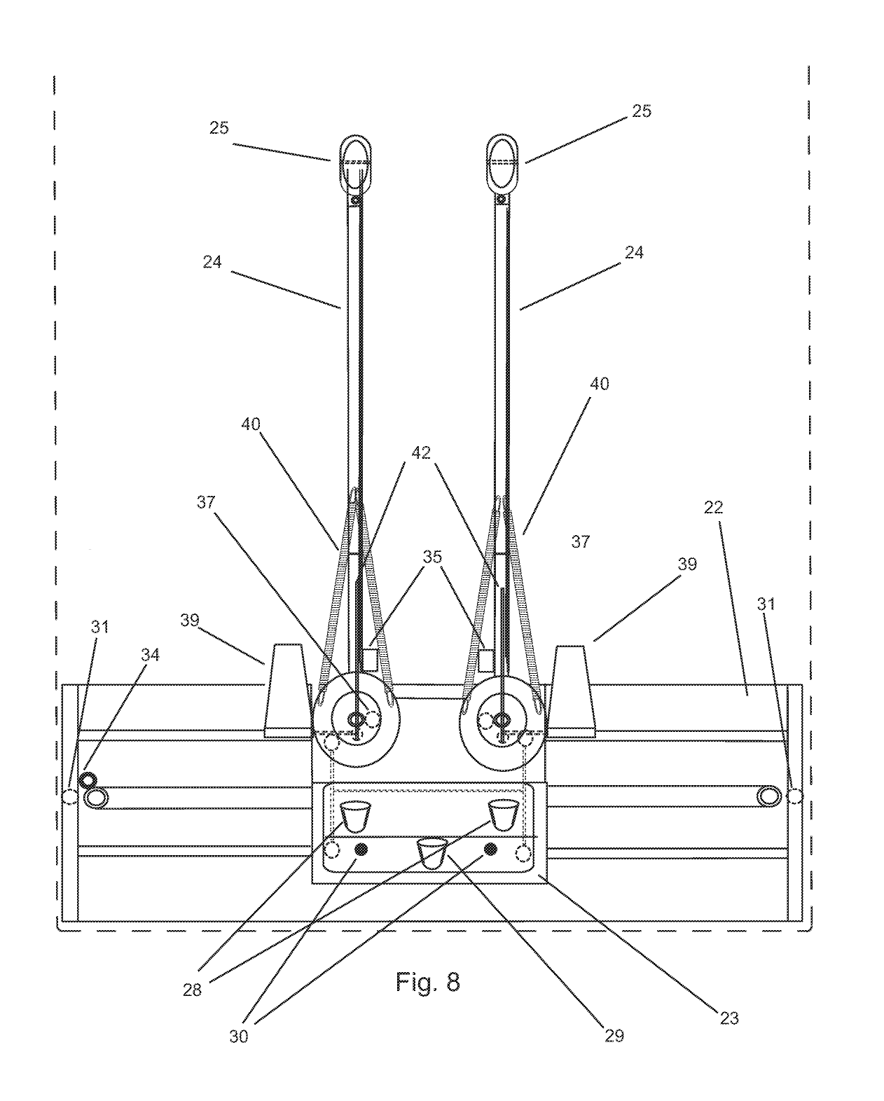

The basic mechanical assemblies of the preferred embodiment are illustrated in FIGS. 7 and 8. They consist of [1.] a first base platform assembly 21 with motorized feet that constantly balances itself to be level at all times, [2.] a second platform assembly 22 above the first with dual rails that can be continuously raised and lowered by means of a motorized scissor lift mechanism, [3.] a third motorized platform assembly 23 that traverses along the two rails of the second platform, [4.] two motorized contact pole assemblies 24 attached to the third platform capable of moving in an up and down or side to side direction, two conventional contact shoes 25 capable of some up and down mechanically designed movement.

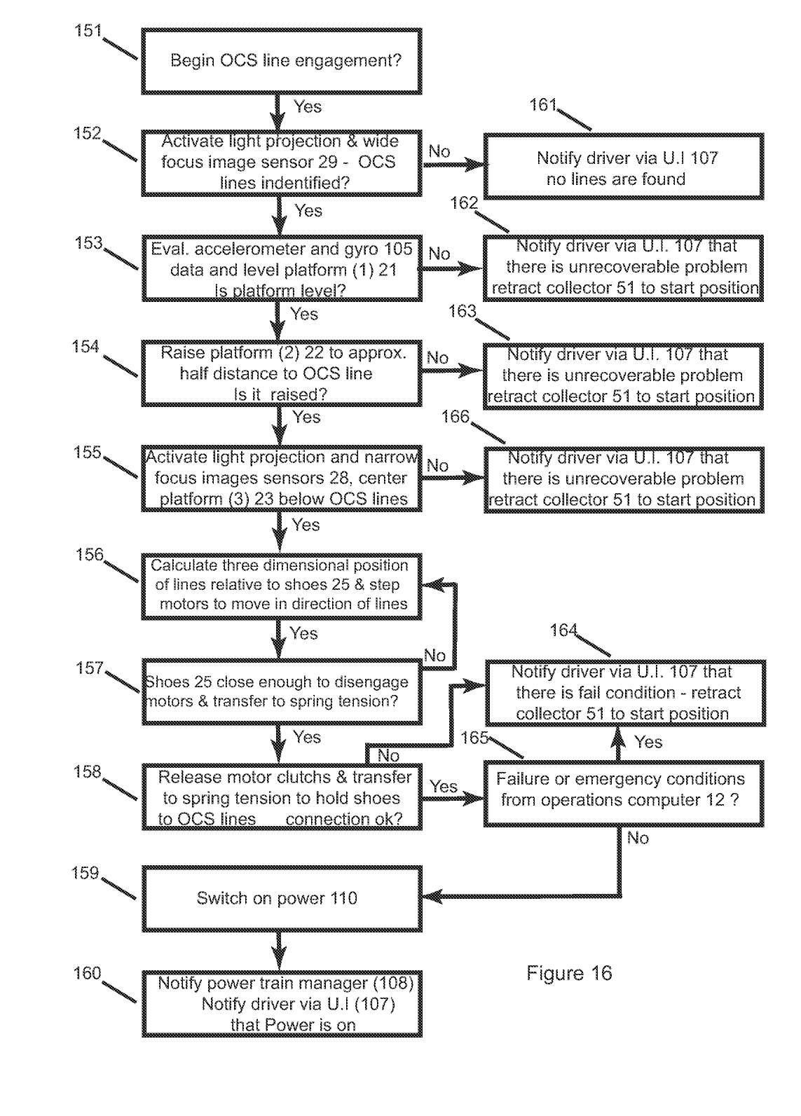

The flow chart of FIG. 16 outlines the operative steps in robotically attaching the collectors. Upon a request 151 to initiate overhead line energy consumption from the vehicle user interface 107 the central application processor 104 activates the image sensors 28 29 and light projection systems (not shown). It then captures images from the wide angle image sensor 29 in order to first establish that the OCS lines exist 152 and their more general location relative to the vehicle 7. In this first stage, the central application processor 104 is attempting to recognize an image of both lines. If an image is recognized as the potential lines the central application processor 104 activates 153 platform one 21 and by communicating with the gyroscope 105, accelerometer 105, and magnetometer 106, adjusts the two motorized sides 31 of platform one 21 until the platform is level from side to side. This leveling process will now be performed continuously within the multi-tasking environment of the central application processor 104 so that platform one 21 remains level as the vehicle 7 travels on potentially uneven surfaces. This leveling is limited in that it does not occur in the direction of travel. If the vehicle 7 is traveling down a six degree inclined roadway the platform would likewise be inclined six degrees in the same direction. The central application processor 104 now uses both the wide angle image sensor 29 and the two narrower focus image sensors 28 to retain position and now, using stereo photogrammetric or stereoscopic calculation or other accurate means of measuring distance and position calculation, calculates the actual distance the lines are from the platform one 23. If this distance conforms to a reasonable value, the central application processor 104 directs the motorized platform two 22 to rise 154 to a position of a determined value. Platform two 22 is also continuously tracked and repositioned. Again, by analyzing image sensor data 155 for the overhead line position the central application processor 104 then directs platform three 23 to be positioned directly below the center of the OCS lines. Platform three 23 is also continuously tracked and repositioned.

With platforms one 21, two 22, and three 23 in position the central application processor 104 directs 156 the two poles 24 with shoes 25 individually towards their respective lines until contact is made. This is performed by activating each poles horizontal 37 and vertical 35 positioning motors and image sensor verification. With contact made 157 and sufficient pressure applied, the central application processor 104 disengages 158 the pole motors and contact continues by mechanical means of the upward compressive force of a spring 26. With contact made and current confirmed power is then switched on 159 to the power train manager 108 and driver is also notified 160 of successful attachment via the user interface 107. Constant repositioning by platforms one 21, two 22, and three 23 continues until OCS line disengagement. If a failure to connect for any reason occurs the driver is notified 161 162 163 164 166 with appropriate message.

The preferred embodiment extends this spring design to two springs 26 offset in opposite directions and in a diagonal plane to the direction of the contact poles 24 (see FIG. 8). The dual spring method provides an additional means of stabilization crosswise to the intended shoe 25 position. Each pole assembly 24 is also assisted by two mechanical wind force neutralizers 27 39. These act to mitigate the effects on the pole assemblies 24 of cross winds to the direction of travel and also to counteract or offset the variable downward tangential wind forces on the pole due to movement speed of the vehicle 7. Each wind force neutralizer 27 39 is designed with a surface area that, when wind tested, exactly offsets the pole/shoe wind force. The design of the wind force neutralizers 27 39 is such that the wings of the wind, force neutralizers can freely rotate in the same horizontal or vertical directions as the poles but are geared to oppose each other thus negating the variable force of wind. The use of wind force neutralizers 27 39 doubles and transfers the original wind force to each pole turret, of platform three. These two-axle pole turrets and platforms would be designed with sufficient strength such that the wind force creates no movement.

The preferred embodiment for the contact poles 24 is a design based on a truss pole design using high strength composite rod (not shown). Poles would have a triangular body shape pointing in the up direction when in use. This truss or lattice design has significantly less surface area thus it has significantly less resistance to the wind or air flow at operating speeds. It will also incur less impact from ground force winds in a lateral direction to vehicle travel. The raising of the second platform 22 to half the distance to the OCS line reduces the conventional length of the poles 24 by 50%. This also significantly reduces total force of air flow resistance on the contact poles 24 at the point of shoe 25 contact on the line. It should also be stated that the distance between the two poles 24 attached to platform three is the same as the distance between the OCS lines. The poles and shoes are thus in a natural alignment with the OCS lines.

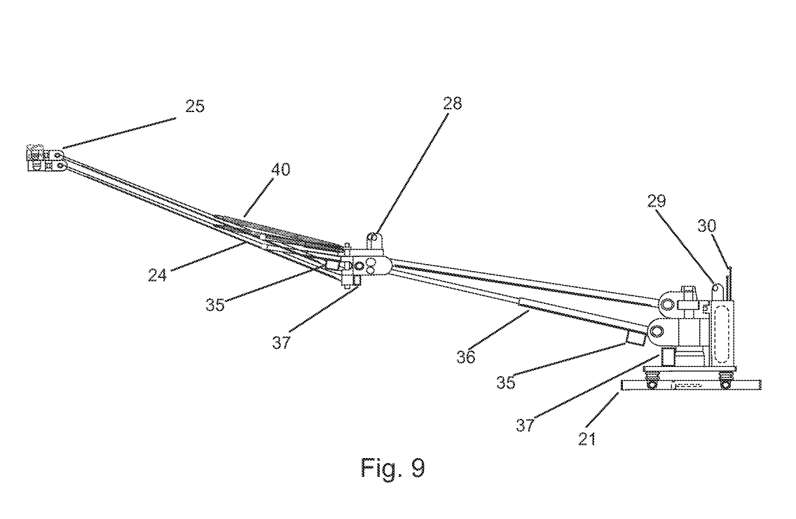

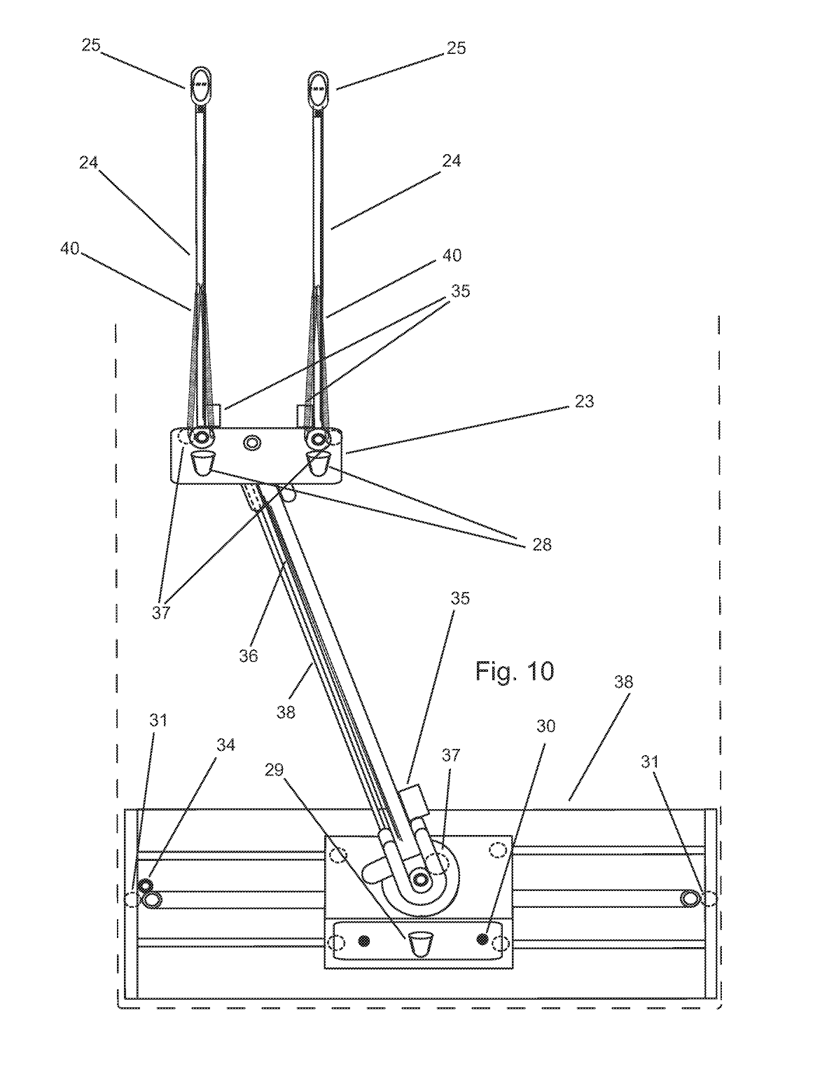

As an alternative to the mechanical assemblies of the preferred embodiment, a double arm mechanism of FIG. 9 and FIG. 10 can also be used whereby platforms two 22 and three 23 are substituted by third pole assembly 36 with motor controls similar to the contact pole assemblies 25. In this case platform three 23 would be assembled and geared such that as the third pole assembly 36 moves its platform always remains parallel to platform one 21 and in pointed in the opposite direction of travel. This is accomplished with the motorized third pole acting to level the platform (horizontal axis) and one additional pole 38 (see FIG. 10) added to maintain the platform in the direction of travel (vertical axis) Wind force neutralizes 27 39 may or may not be used in alternative assemblies. This alternative also illustrates the option of the wide angle image sensor 29 being placed on platform two 22 while the narrower focus image sensors remain on platform three 23. This alternative can also be further extended by being set on a multifunction platform 59 (see vehicle of FIG. 3) with the rails of platform two 22 but no scissor lift and a moveable platform three 23 as a base for the double arm as shown in FIGS. 7 and 8. This extension provides such extended lateral movement that under limited conditions the vehicle could leave the lane while still connected to pass an obstruction.

An exemplary tractor-trailer design for this initial roadway embodiment is illustrated on FIGS. 3, 4, 5, and 6. It should be clearly stated that the object of this invention is to provide the components to commercially supply electricity on-demand—not to design tractors or trailers. It is envisioned that there will be adequate qualified designers and builders such that a commercial specification can be developed as to the actual details of energy distribution. Independent designers will individually provide hybrid electric trailer and tractor solutions. Much like a power utility's role and responsibility ends at the house electric meter so too does this present invention stop at the meter 109 (see FIG. 14). All further electricity and energy management issues are dealt with by the tractor or trailer manufacturer. For purposes of definition within this invention, it is assumed another intelligent processing environment will be involved for this and it will be referred to as powertrain management 108. The central applications processor 104 of this invention 104 and the powertrain management 108 would communicate electronically at high speed via the Ethernet connection or other electronic connection cooperatively defined with the power train manufacturers.

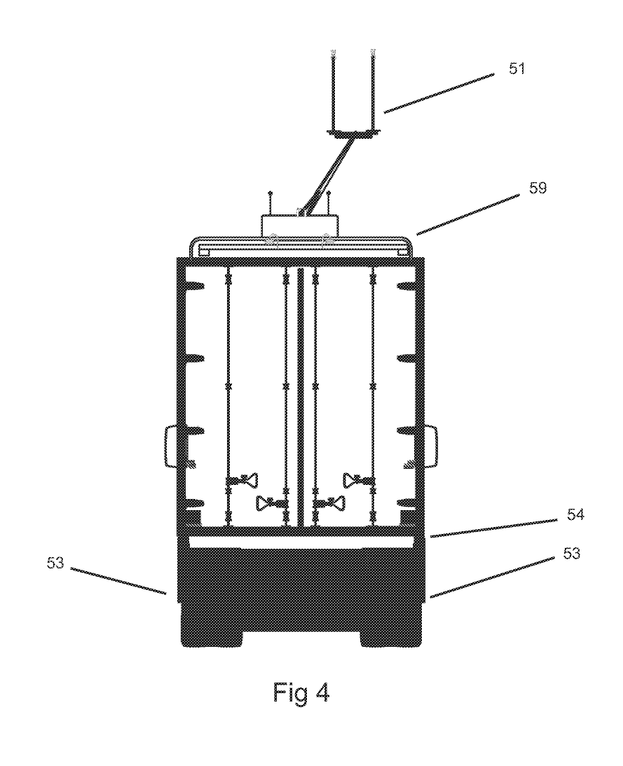

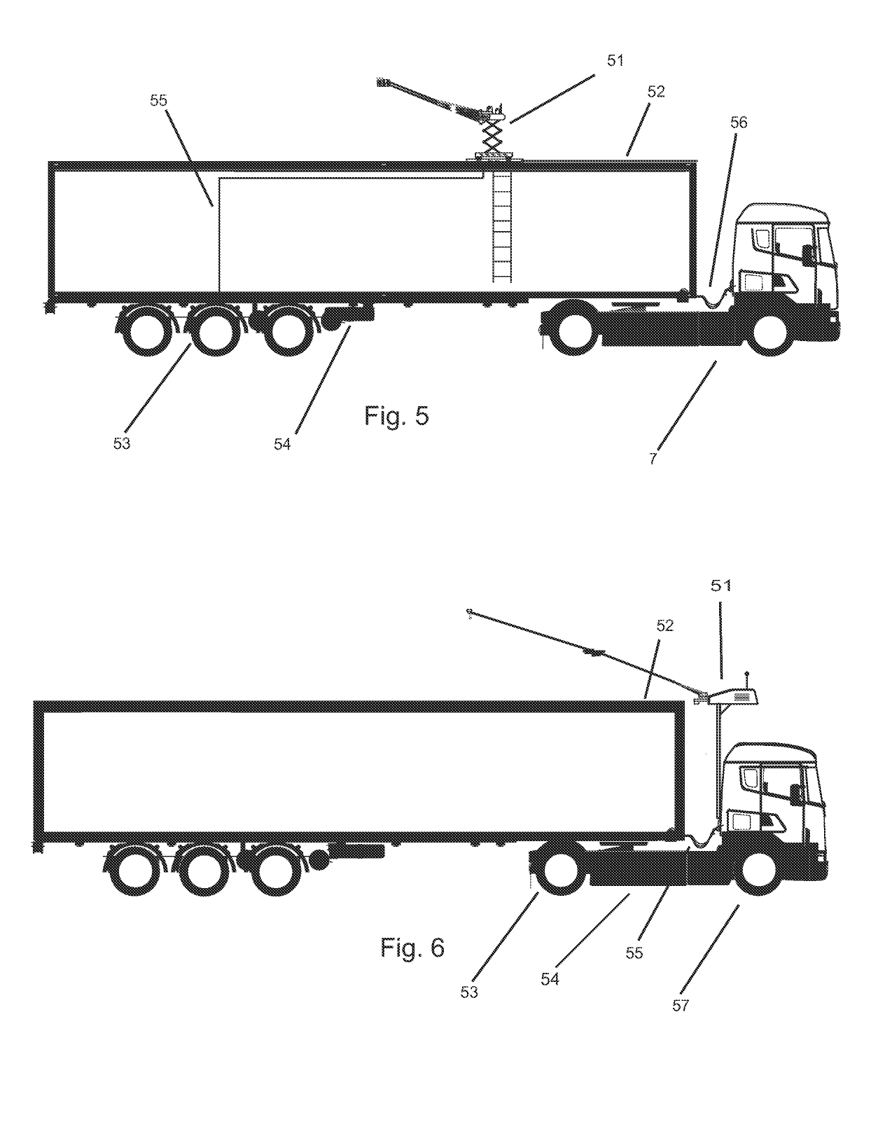

FIG. 3 illustrates a front view of a hybrid diesel tractor 7 with an electrified trailer. While this illustration shows a license plate type number 52 on the face of the shroud covering parts of the robotic collector module 51 it is more likely this identification might involve a bar code or other industry approved electronically readable system. Each segment manager module 6 also has wireless communication with the vehicle so that an electronic identification can also take place. FIG. 4 illustrates the rear view of same. The side view illustrated by FIG. 5 provides a more complete summary of the vehicle centric components. The collector 51 is placed on top of the trailer and is shown in the raised position. It may become more advantageous for the collector 51 to be mounted on the front wall of the trailer (not shown) in a similar location to where a refrigeration unit would normally be. This allows the trailer to fully retract to a height at or below the current maximum trailer height. Electric motors would be integrated into the rear wheel assemblies 53 with an electrical line 55 connecting them to the collector. It is envisioned that some battery storage 54 will be required to meet the previously mention specifications. A computer communication cable 56 travels from the collector to the powertrain management processor 108 likely located in the truck or cab sections. A second such cable (not shown) may exist for a wired user interface device to be placed in the tractor cab. Another exemplary implementation would integrate the user interface of this invention with the user interface of the powertrain management processor 108. This would likely simplify and improve the user experience. In such a case the collector 51 would still communicate with the user through the computer communications cable 56 and an enhanced specification would be provided for this option.

The initial marketplace would be upgrade kits for the existing world inventory of tractors and trailers. These upgraded vehicles look identical to the new vehicles of FIG. 3, 4, and 5. It becomes quickly obvious that a pure electric tractor 57 with more robust battery storage and no diesel engine is an additional solution. FIG. 6 illustrates such a tractor. This solution enables at least limited ability to propel the vehicle beyond the electrified roadway and would become a much more price competitive transportation alternative on electrified roadways. This is particularly the case for pulling legacy trailers without electric motors. In this case an enlarged battery is integrated with the tractor 54 and electric motors are thus installed on the rear tractor wheels 54. A pure electric tractor is envisioned as a second stage development because a very high degree of overhead energy reliability must be present for these vehicles to be successful. In an energy failure situation, a diesel/electric vehicle just continues under conventional diesel power. Pure electric vehicles may have to wait for energy and also may require charging stations. It is also obvious that for newly manufactured tractors a significant reduction in diesel engine horsepower can occur when coupled with a trailer with electric motors and this reduces tractor costs and weight.

There are other advantages accruing to the tractor itself as a result of this invention. While tractor diesel motors are built to operate and last a long time, electric motors last even longer. Electric motors have essentially one moving part with little friction or operating heat. It is not unusual for an electric motor to be 95% efficient. It is envisioned that these electric tractor motors will go 1.6 million kilometers without the need for servicing. They should also maintain this same high operating efficiency throughout their life unlike diesel engines.

Another significant object of this invention is to reduce road noise over time to a level of near silence. These diesel/electric and fully electric tractors will also perform in a near silent mode compared to the current very high noise level of legacy diesel tractors. In addition to being of benefit to the driver, other drivers as well entire communities close to the roadway will also benefit from the significant drop over time of noise due to legacy diesel tractor engines.

### Robotic Collector Module 51—Computer Process and Control

Computer processing and communications distinguish this invention both regarding the operation of the energy collector but also the entire business model in general. The vehicle robotic collector module integrated circuit board(s) are functionally illustrated in FIG. 14 including a description in electronic component terminology. There are eight motor controls to perform the robotic movements previously described. Motor [1] 91 and Motor [2] 92 exist at each end of platform one and act to raise or lower each side in order to level the platform. The robotic collector module of this embodiment is a motion sensitive device containing self-contained electronic inertial sensing devices including a 3-axis accelerometer 105, a 3-axis gyroscope 105 and a magnetometer 106. Gyroscope 105, magnetometer 106, and accelerometer 105 hardware components, such as the Invensense MPU-6000, would be mounted on platform one as an example, while duplicate devices may also exist on platform three to provide additional function. While it would be possible to mount the majority of components on or under platform one, FIG. 9 shows the image sensors and communication antennas, for instance, mounted on platform three. An alternative embodiment could include the two narrow angle image sensors mounted on platform three with all communications and the wide angle image sensor mounted on platform one or two. Motor [3] 93 raises and lowers the scissor lift of platform two. Motor [4] 94 moves platform three laterally to position the poles directly below the two contact lines. Motor [5] 95 rotates pole (1) 24 in the horizontal direction (vertical axis). Motor [6] 96 rotates pole (1) 24 in a vertical direction (horizontal axis). Motor [7] 96 rotates pole (2) 24 in the horizontal direction (vertical axis). Motor [8] 98 rotates pole (2) 24 in a vertical direction (horizontal axis). The described preferred embodiment of the robotic collector 51 uses electric motors to direct movement. Trucks and other vehicles can also use hydraulic (fluid) or pneumatic (air) pressure systems to serve the same purpose as both are also typically available on vehicles.

The central application processor 104 performs other vehicle centric safety functions in addition to monitoring and adjusting the collector pole components. By monitoring the values from the accelerometer 105 any sudden impact can be detected and an immediate shut down of the collectors would occur. The central application processor 104 can also sense a significant change of vehicle direction from the gyroscope 105 data and then also begin a shut down, An example would be if the driver needs to quickly leave the lane. In this case the driver does not need to take any additional action beyond just driving out of the lane. The driver would be made aware of disengagement by the central applications processor 104 via the in-cab user interface 107.

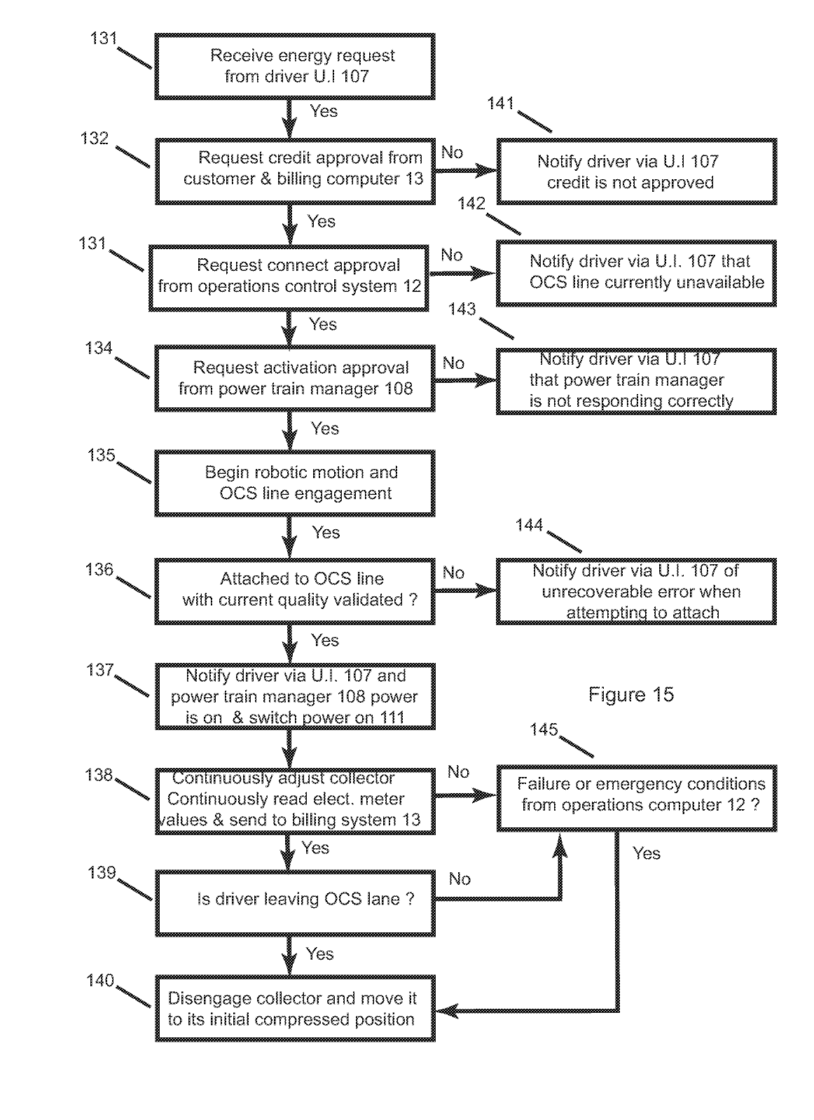

The flow chart of FIG. 15 outlines the overall operative steps performed by the robotic collector modules' central applications processor 104 in addition to motion control of the collector mechanism. Many of these additional functions are interrupt or event driven and the central applications processor 104 is a multitasking processor—meaning the selected processor has sufficient power that all tasks are seemingly handled simultaneously. The process always begins with a request 131 from the driver for power. When this request is received and before any movement begins of the collector the central applications processor 104 will wirelessly request credit approval 132 from the customer and billing computer system 13. The likely form of initial communications will by using the industry standard mobile phone communications hardware 112 integrated within this design. If approved, a request is then made to the operations computer system 12 for status of electricity at the exact point on the roadway of the vehicle 51. This request 133 will also contain specific instructions as to rate of consumption of power. For instance, if the roadway is currently experiencing heavy traffic, a much lower rate of consumption will be authorized. Such communication between the operations computer system 12 and the central applications processor 104 will continue to occur with power levels raised and lowered for the duration of electrified travel. Before switching on power the central applications processor 104 will always confirm 134 the power train manager is active.

The robotic movement 135 136 137 involved in attaching the collector poles to the OCS then takes place as further described in detail in the flow chart of FIG. 16. The central applications processor 104 also maintains constant communication with the customer and billing computer system 13. The consumptive use data obtained by reading the vehicle 51 electric meter 110 is forwarded on a timely regular schedule. It is anticipated any credit issues will be resolved by the driver or his company employer before the vehicle 51 enters the roadway and actions such as “unplugging” power to the vehicle 51 would be an extreme solution. Messages will be sent via the driver user interface 107 at all times indicating “how full” the vehicles 51 credit account is. Some type of alarm message would be sent well before power is interrupted.

There are two methods of determining the driver is intending to leave the electrified lane 139. The first is by calculation of the position of the collector platform three and poles. If the combination is such that they are at the extended position and further extension is now not possible the collectors will be retracted. The other method is to determine the vehicles current direction of travel by analyzing accelerometer 105 values. If the direction of travel now indicates the vehicle is leaving the lane then the robotic collector module 51 will be retracted automatically 140. The accelerometer values 105 in combination with other values such as gyroscope values 105 will also be used for safety purposes similar to Electronic Stability program (ESP) functionality of new mainstream automobiles which sense the direction of the vehicle does not match its actual direction of travel indicating skidding conditions. The robotic collector module 51 will also be retracted automatically in these emergency situations 145. The central applications processor 104 will at all times inform the driver via the user interface 107 with appropriate messages as to conditions and actions taken 141 142 143 144.

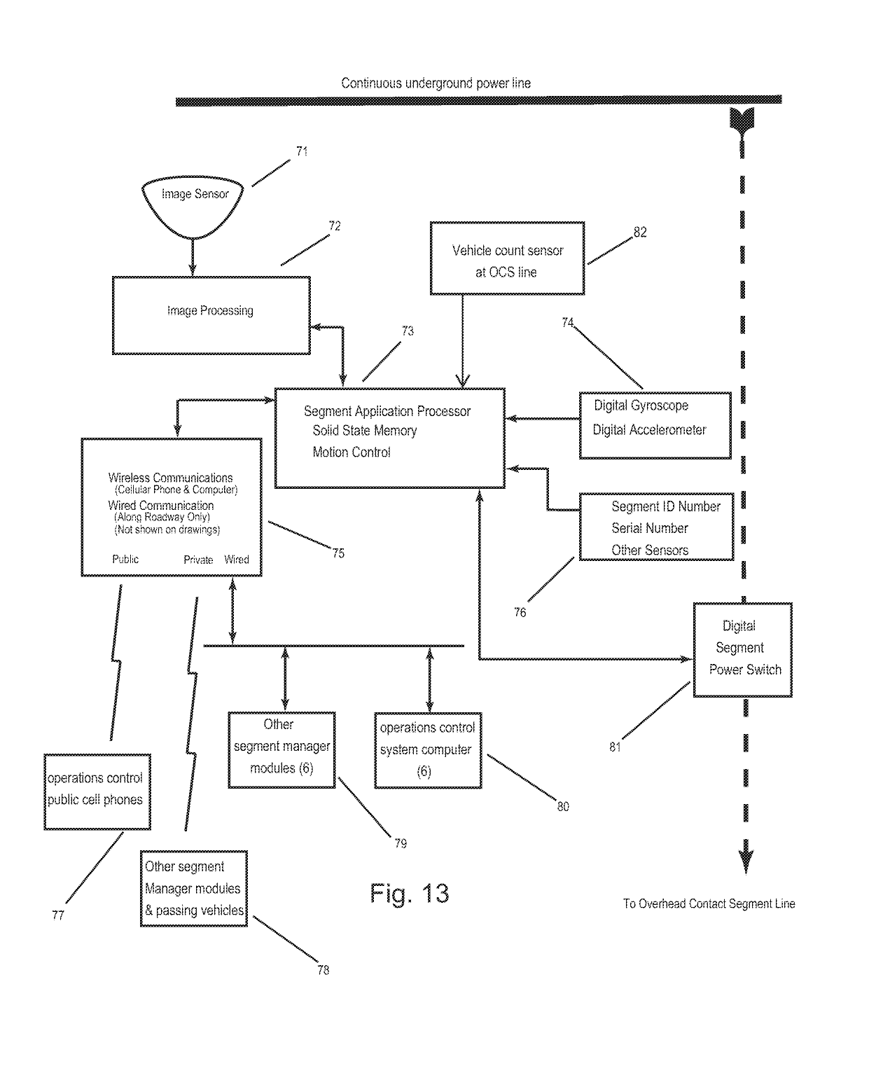

The entire technology sector of what is referred to as MEMS (Micromechanical System) inertial sensing devices, such as accelerometers and gyroscopes, is a rapidly advancing and commercially booming sector. It has been forecasted that all new mobile phones will contain similar devices by the year 2014. The computer gaming industry also continues to be a driving force in all sensor technologies. FIGS. 13 and 14 are functional block diagrams of the components which manufacturers are now consolidating into single chips. In 2011, with now a plethora of options of applicable sensor product offerings, hundreds of exemplary hardware integration designs of this invention are possible. It is envisioned that as time progresses and further technology evolution occurs in this MEMS sector new and improved exemplary hardware designs of this invention will fully replace those existing in 2011. The central processors and special purpose chip-based hardware described herein are now well known and many details are omitted to allow the reader to focus on the salient aspects of the embodiments described herein. Actual implementation will also involve use of application software libraries developed or recommended by MEMS hardware vendors for optimal use with their chips or hardware. This includes but not limited to operating systems, image processing and recognition software, motion control software, inertial sensing software, and communications software.

The described preferred robotic collector module 51 embodiment is also based on a conservative, first generation type design. It likely will become possible over time and based on actual usage and reliability data to use but one image sensor, for instance, rather than the three described in the preferred embodiment to adequately perform the functions of this invention. Likewise, hybrid blends or combinations of inertial sensing chips or currently less proven 3-D calculation software may also eventually reduce the number of chips described as necessary.

Reliability issues regarding use and electronic billing are critical to real-time operation. The robotic collector module 51 also contains three industry standard communications modules 112 for communication over industry standard networks. The first is a wireless internet standard ability with which to communicate with the network of mast pole segment manager module 6 which would always be within 30 meters of the vehicle. The second module is a standard cell or mobile phone module that would be used for data communications where necessary. The third is wired communications of Ethernet standard for hard wire interconnecting on the vehicle. It is presumed that the vehicle will also have another control processor referred to as the power train manager 108 for actually managing power distribution between diesel engines and the electric motors.

It is envisioned that all of the vehicle components of this invention would be uniformly manufactured and distributed by the line operator while the power train manager 108 would be designed and built by the vehicle manufacturer. The central applications processor 104 of this invention stops at opening the flow of electricity and monitoring its use both in terms of quantity used but also whether the vehicle power train manager 108 is adhering to energy usage instructions passed through from the overall system operations computer. The central applications processor 104 can communicate with both the billing system and the operations system on-demand and in real-time regarding billable conditions. The onboard electric meter 110 is envisioned to also be the source of a unique identification number similar to mobile phone serial numbers. It becomes critical that this power line stay at a very high level of service and availability for transportation professionals to depend on it. These redundant communication options seek to ensure this happens. It is also envisioned that the speed of the vehicle, as well all other needed historic data, can also be logged in static memory and reported through communication, This is accomplished with the integrated global position sensor and a mechanical wheel sensor 106 that may also have an odometer readable from the wheel.

### Roadway Electrification and Network Electronics

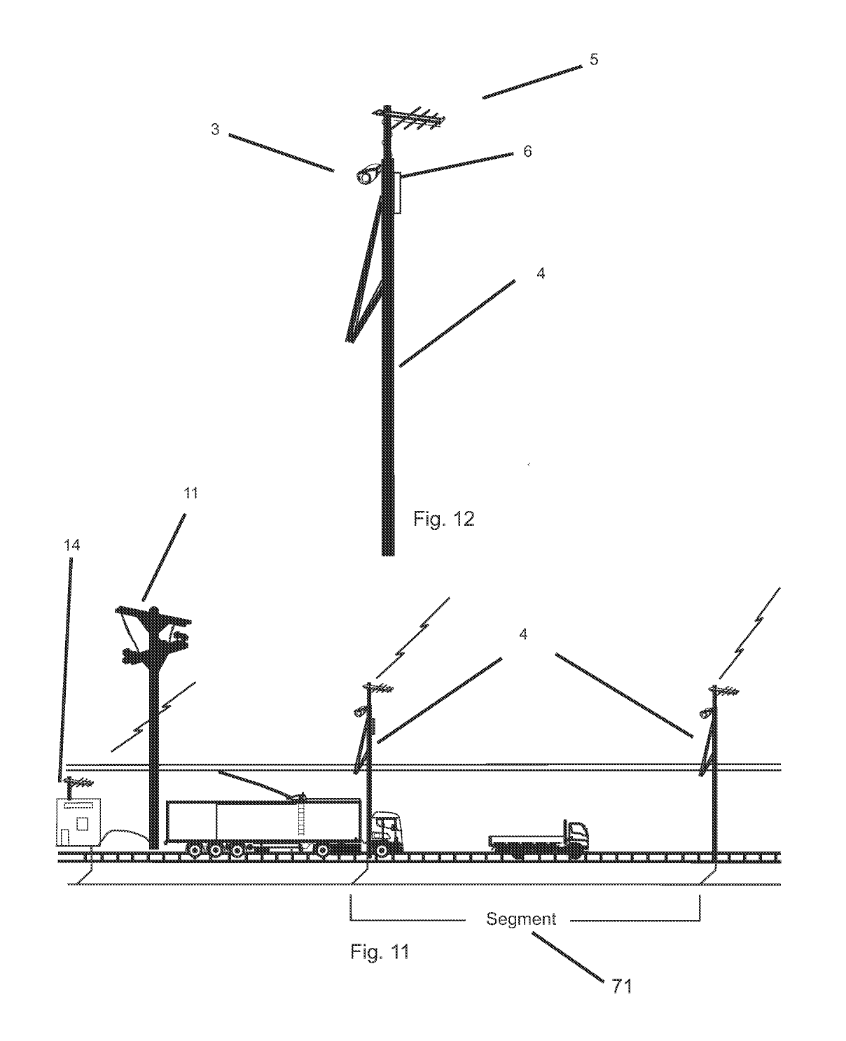

FIGS. 11 and 12 illustrate the mast pole segment manager module 6 and OCS components of the preferred embodiment. Again, one important design feature of the present invention is that there really are no changes to the roadway itself that impact legacy vehicles and drivers, All lanes remain the same at surface level and the electrified lane 1 is not a restricted lane. Coexistence of the two environments is key to a success and smooth transition. This invention, in addition to the implementation of conventional OCS components, adds a computer network that runs in parallel to the electrical lines for the full length of the roadway. This is a roadway operations focused network that has both wired and wireless communication options equal to the vehicle robotic collector module 51. While not shown on the drawings each segment manager module 6 would also contain a battery backup capability to further ensure availability in the event of an accident. Each mast pole has its own intelligent segment manager module 6 further illustrated by the block diagram of FIG. 13. A segment is defined as that distance of roadway between mast poles monitored and automatically controlled by the segment manager module 6, This distance will range between 30 and 60 meters. In the preferred embodiment each segment would be electrically isolated from its neighbor segments. An underground bypass line would continue supplying energy to the next segment. The segment manager module 6 thus under certain defined circumstances can disable the energy to the overhead line without impacting energy on other segments. Vehicle power designs must routinely handle such segment energy isolation gaps and potential segment energy interruptions.

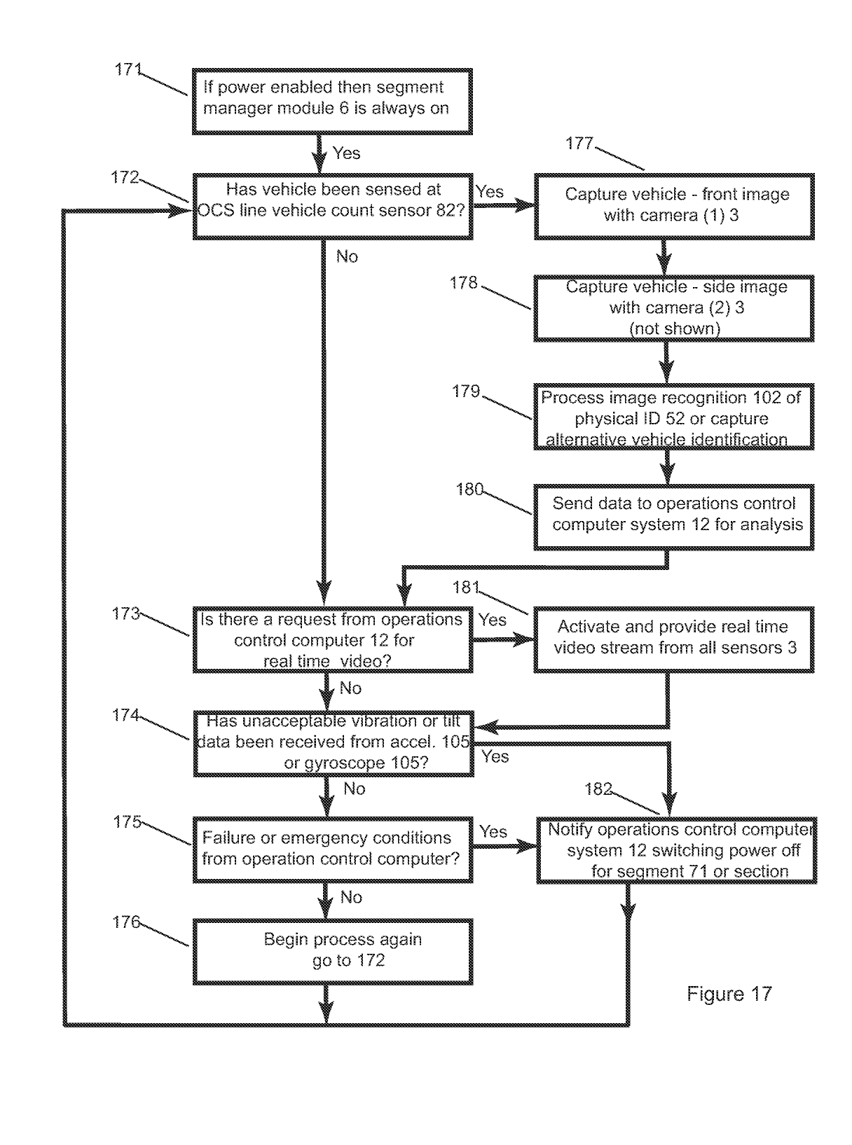

The flow chart of FIG. 17 outlines the overall process. The segment manager is an always on module that interacts with traffic while also sensing problems with the OCS components. An OCS line sensor 82 senses any collector passing by and contacting the OCS lines. When a vehicle is sensed 172 the segment application processor 73 initiates image capture 177 by the camera 71. Another exemplary embodiment would have two 178 or three cameras so that top, front and side images can be taken of the vehicle 51. Image recognition processing 179 may also be done if a bar code or another readable identification is present. All data is then sent 180 to the operations control computer system 12. In the event someone at the operations control system computer has cause to wish to view video at this particular segment, upon request 173 a video stream can be activated from the cameras. If the segment application processor of the segment manager module 6 receives shock data from the accelerometer 74 indicating possible impact or receives tilt data from the gyroscope 74 indicating the pole is in a failing position 174, energy can be switched off 81 before possible hot power lines reach the ground or land on a vehicle. It would then also report the condition to its neighbors for possible additional instantaneous action and also to the operations control system computer 12. The segment manager module will also act as a network connection for conventional OCS electronics that monitors electrical function 76 (not shown).

Another exemplary and more cost efficient embodiment would be to implement the above segmentation method using entire sections of OCS line. Conventional sections of OCS line, while variable in length, are much longer than the distance between mast poles. This would mean multiple mast nodes are managing the same section of line and more line will be down if a mast node senses failure and disables section energy. Another advantage of this embodiment is the entire OCS electrical line system is composed of proven convention OCS components already in production. A section is defined in conventional terms as the length of line between locations where circuits would normally exist to isolate electric energy.

The segment manager modules 6 also enable data communication with user vehicles providing road condition info in such circumstances. An additional function of the segment manager module 6 will be to manage a traffic light advisory system (not shown) making all drivers aware, in a simplistic way, of the state of the OCS and if emergency road conditions may exist. Each segment manager module 6 and thus each mast pole will have a hardware identification number 76 that allows operations personnel to absolutely pinpoint roadway issues. In the early stages of operation it is envisioned that most communication from the vehicle will be by the mobile phone communications option back to the operations control system computer 12 which then communicates with the mast pole segment manager modules 6.

Each mast pole also has a camera(s) connected to the segment manager module 6 for viewing its segment space. This camera can be accessed by the roadway operations center. While FIGS. 11 and 12 show the camera mounted on the mast pole, another logical location would on the bracket arm centered between the OCS wires and pointed directly into oncoming traffic within the electrified lane. The segment manager module 6 can also validate a vehicles external description and a visual identification such as a bar code (not shown) on the shroud of the robotic collector module. Theft prevention is significantly enhanced by this capability as an offending vehicles position and vehicle description is known constantly in real-time. Each segment manager module 6 also contains image processing functionality for high-speed recognition and could be requested by the operations control system computer 12 to provide an alert based on a certain image type which might be a color or shape of vehicle. The FIGS. 11 and 12 of the segment manager module 6 depict rather large antennas and cameras for illustration purposes only. In the preferred embodiment the size will be very small and likely that of a small mobile phone. The cameras, in particular, should barely be noticeable by non-electric disinterested drivers. Mast pole segment manager modules 6 also will be logging usage of the segment with images. Such data can be used to evaluate accidents and other road conditions in order that the best evaluation and actions can be taken to improve the OCS environment particularly as it applies to safety. On a regular scheduled basis such data will be then uploaded for storage and management to the operations control system computer 12.

Speed of vehicles 51 needs to be monitored especially in the formative stages of implementation. There are two ways speed will be measured. The first method provided is for the robotic collector module 51 to simply communicate its known speed based on its internal global position sensor 106 to the operations control system computer. The other method will be for the segment manager modules 6 to calculate the speed based on an average of its mast pole to mast pole incremental times. As the purpose of this recording is for analysis purposes and overall safety there is no plan to make the data public.

The primarily computer system architecture of the preferred embodiment would be one of “cloud computing”. Very little independent data would be even temporarily stored in the memory or storage resources of either the robotic collector module 51 or the segment manager module 6. In so doing, it is envisioned a much higher level of performance can be achieved. Overall system reliability, availability and serviceability can also be developed to a higher level. As the number of vehicles grows and roadways become electrified such architecture can expand and scale to meet the new needs. Little or no information can ever be lost due to vehicle accidents, vehicle power losses, or vehicles being completely out of communications range.

The billing system environment for electricity usage would most closely resemble a mobile phone system where users are billed by the minute. This unit type billing is known and understood virtually throughout the world due to the vast success of these phones. It would therefore be favorably accepted by users. Account and user data would be available via the World Wide Web or Internet. This information would be available to the driver in real time or to other company employees at all times. Credit would be established and maintained by accepting acceptable credit card numbers from the users.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A method of commerce for electricity sales and distribution to roadway vehicles comprising:
a. a roadway containing a means for distributing electricity to traveling vehicles,
b. a plurality of independently owned and operated vehicles each comprising (1) an electric motor for traction, (2) electricity collectors for connecting with and drawing from the distributed electricity, (3) an electricity metering device for measuring electricity usage, (4) an electricity switch for enabling or disabling electricity use, (5) an intelligent processing module, with a unique digital identifier and a wireless communications module for monitoring said meter, manipulating said switch, and communicating with a controlling host computing site to request use authorization and report usage while traveling on said roadway,
c. a controlling host computing site with wireless communication for communicating with and authorizing electricity use of said vehicles and billing said independent operators for reported usage on behalf of the proprietor of the electricity source,
whereby electricity is accurately billed and accounted for and drivers are presented with a safe and easy to use transportation environment.

2. The method of claim 1 wherein said controlling host computing site comprises a continuously wired, computerized network constructed on or adjacent to the overhead electrical contact wire pole assemblies alongside the roadway for further monitoring.

3. The method of claim 2 wherein said computerized network comprises intelligent processing modules with inertia or gyro sensors mounted on said pole assemblies for sensing data changes from said sensors, analyzing for condition of vehicle-pole collision impact or pole inclination, and then immediately de-energizing a local section of overhead electrical contact line if such a condition is realized.

4. The method of claim 2 wherein said computerized network comprises intelligent processing modules with digital imaging devices for recognizing a unique physical identifier displayed on said vehicles and communicating results to said controlling host computing site for authentication purposes.

5. The method of claim 2 wherein said computerized network comprises intelligent processing modules with wireless communications capabilities for direct communication to said passing vehicles or neighboring said intelligent processing modules.

6. The method of claim 5 wherein said vehicle's unique digital identifier is communicated by said vehicles to said computerized network intelligent processing modules and then communicated by said intelligent processing modules to said host computing site for vehicle authentication purposes.

7. The method of claim 5 wherein said vehicles, or said host computing site, or said computerized network processing modules comprises cellular communications modules for communication routing via a commercial carrier.

8. The method of claim 1 wherein said vehicles comprise an autonomous robotic electricity collector apparatus capable of attaching or detaching from electrical line while vehicle is in motion based on electronic communication with said controlling host computer site.

9. A vehicle with robotic current collector for drawing electricity used for traction comprising:
a. a programmable controller apparatus,
b. a first pole with a current collector contact device at one end and with the other end attached to a first multi-axis turret assembly with base mounted to vehicle,
c. a first actuator connected to turret and said first pole for raising and lowering said first pole based on instruction from said programmable controller apparatus,
d. a second actuator connected to turret and turret foundation for rotating turret with respect to vehicle based on instruction from said programmable controller apparatus,
e. a means of image detecting wherein image data is communicated to said programmable controller apparatus for identifying the overhead lines and their position relative to the vehicle,
f. a means of interfacing with the vehicle operator by said programmable controller apparatus for activating and controlling operation,
Whereby programmable controller apparatus analyses image data to calculate distances and cause actuators to move the poles side to side, and up and down, until actual contact is made with electricity lines.

10. The vehicle with robotic current collector of claim 9 wherein said vehicle comprises an inclination detecting means for detecting the pitch, yaw and roll angle of said vehicle with respect to gravity and the direction of travel, and a means of communicating the values of said angles to robotic controller apparatus.

11. The vehicle with robotic current collector of claim 9 wherein said robotic current collector comprises:
a. a first platform attached to the vehicle that is rotatable in a third axis in the transverse direction to the line of travel with the turret assembly mounted on it rather than the vehicle,
b. a third actuator connected to said first platform for positioning said angle of said first platform based on instruction from said programmable controller apparatus.

12. The vehicle with robotic current collector of claim 9 wherein said first platform comprises:
a. a guide assembly mounted to the vehicle in a transverse direction to the line of travel along which said first platform is attached and can move along said guide,
b. a fourth actuator connected to said first platform and said guide assembly for positioning said first platform along said guide assembly based on instruction from said programmable controller apparatus.

13. The vehicle with robotic current collector of claim 9 wherein said robotic current collector comprises:
a. a means of mechanically raising said first platform such that it can be vertically raised and lowered above said vehicle,
b. fifth actuator connected to said first platform for positioning said first platform above said vehicle based on instruction from said programmable controller apparatus.

14. The vehicle with robotic current collector of claim 9 wherein said vehicle comprises: a digital electricity meter and a means of communicating values of said digital electricity meter to programmable controller apparatus.

15. The vehicle with robotic current collector of claim 9 wherein said vehicle comprises: a digital identification number and a means of communicating values of said digital identification number to programmable controller apparatus.

16. The vehicle with robotic current collector of claim 9 wherein said vehicle comprises: a means of wireless communications and a means of communicating the data from said means of wireless communications to programmable controller apparatus.

17. The vehicle with robotic current collector of claim 9 wherein said vehicle comprises: a means of detecting acceleration and a means of communicating the values of said acceleration to programmable controller apparatus.

18. The vehicle with robotic current collector of claim 9 wherein said robotic current collector comprises: a means of mechanically neutralizing the variable force of air flow directed onto the pole assembly.

19. The vehicle with robotic current collector of claim 9 wherein said robotic current collector comprises:
a. a second pole with first multi-axis turret assembly attached at one end and with the other end attached to a second multi-axis turret assembly with turret foundation mounted to vehicle,
b. a sixth actuator connected to second multi-axis turret and second pole for moving said pole vertically based on instruction from said controller,
c. a seventh actuator connected to second multi-axis turret and turret foundation for rotating turret and pole horizontally based on instruction from said programmable controller apparatus.
